(19) United States
(12) Patent Application Publication
(10) Pub. No.: US 2013/0298893 A1
(43) Pub. Date: Nov. 14, 2013

(54) Compact Lightweight combustible fuels stove

(71) Applicants: Curtis Linville, Golden, CO (US); Travis Parsons, Longmont, CO (US)

(72) Inventors: Curtis Linville, Golden, CO (US); Travis Parsons, Longmont, CO (US)

(21) Appl. No.: 13/467,041

(22) Filed: May 9, 2012

(51) Int. Cl. A47J 33/00; F24C 1/16

(52) U.S. Cl. 126/30; 126/9 B

(57) ABSTRACT

A portable, compact, light-weight, foraged-fuel stove which assembled, provides a sturdy adequate cooking surface and while collapsed, forms a compact case favorable in size and weight for easy storage in pocket, purse, or backpack. The low-profile, square shape of this stove enhances stability and safety while providing a multi-use cooking surface adequate for grilling as well as cooking with pans of most sizes. The stove is designed to work with fuels foraged from one's surroundings, but is also suitable for use with charcoal, gelatinous fuels, alcohol burners, and more. By using foraged fuels, the backpacking weight of this stove is minimized. The stove provides a large opening for adding fuel eliminating the need to move the cooking material to add fuel, and a system of smaller openings in the sides of the stove to allow for adequate airflow to sustain combustion of the fuel.

### REFERENCES CITED

### US Patent Documents

U.S. Pat. No. 1,221,514 April 1917 Crain

U.S. Pat. No. 1,238,142 August 1917 Hitchcock

U.S. Pat. No. 3,109,420 February 1958 Ott, et al.

U.S. Pat. No. 3,146,773 September 1964 Melzer

U.S. Pat. No. 3,683,886 August 1972 Metzner, et al.

U.S. Pat. No. 4,140,099 February 1979 Newport

U.S. Pat. No. 4,794,906 January 1989 Longley, Jr.

U.S. Pat. No. 4,877,010 October 1989 Hait

U.S. Pat. No. 4,971,045 January 1990 Probst

U.S. Pat. No. 5,915,371 June 1999 Herring

U.S. Pat. No. 6,520,173 February 2003 Lautner

U.S. Pat. No. 7,107,983 January 2006 West

### RELATED APPLICATIONS

Most backpacking stoves strive to minimize weight often at the cost of maintaining stability. This can create dangerous conditions for using these stoves in the uneven surfaces found in outdoor environments. Additionally, most stoves require one to carry fuel in the form of some highly volatile liquid or gas stored in bottles or canisters. This fuel often leaks or spills spoiling soils and water runoff, not to mention other items in a backpack. The added weight and cost of the fuel are also marked drawbacks.

While not limited only to foraged fuels, this device does allow the user to backpack without the need to carry heavy fuels. Additionally, the unique stability, light weight, and simplicity of this design set this stove apart from other similar cooking stoves. Also, as an alternative use, the stability of this stove makes it useful as a wind-break and enhanced cooking surface for many other backpacking stoves used today. Examples of previous patents of designs of foraged fuel stoves are listed below. The present invention is more compact, and/or more stable than previously patented devices.

U.S. Pat. No. 1,221,514 to Crain (1917) discloses a cylindrical stove that utilizes foraged fuels. When manufactured to backpacking scale, the opening for feeding fuel to the fire is limiting, and there are inadequate air holes to allow for sustained combustion. Additionally, the cross bars on which one would set a pan create an uneven surface causing instability of the pan.

U.S. Pat. No. 1,238,142 to Hitchcock (1917) discloses a cropped-pyramid stove that might utilize foraged fuels. When manufactured to backpacking scale, this stove has inadequate openings for feeding the fuel. Additionally, the reduced top surface and height of the apparatus create instability. Hinges used to fasten the various parts of the stove add weight to the stove, and create a possible design failure point.

U.S. Pat. No. 3,109,420 to Ott, et al. (1958) discloses a cube shaped device that fastens together using a variety of tabs and slots. The only way to feed the fuel during use is to remove the cooking pan and feed directly into the flames from above creating potentiality for burns and spills. The air intake is accomplished via raising the device from the ground on a system of legs which in soft earth would sink into the dirt eliminating air flow to sustain combustion. Uneven ground could cause one piece to be raised in relation to its adjoining piece potentially releasing the tab-fastening mechanism resulting in failure of the stability and structure of the device.

U.S. Pat. No. 3,146,773 to Melzer (1964) discloses a cube or rectangular-box shaped device that could use foraged fuels that fastens together with a variety of metal corner folds and grill-wires. The only way to feed the fuel during use is to remove the cooking pan and feed fuel directly into the flames from above creating potentiality for burns and spills. The cooking grate is the largest piece of the device, and results in a less compact unit with dirty cooking surface exposed when the device is stowed.

U.S. Pat. No. 3,683,886 Metzner, et al. (1972) discloses a foldable rectangular box stove designed for use with canned heat. The stove has very little ventilation to allow for airflow necessary to sustain combustion of foraged fuels. The stove folds with a system of hinges and wires that add weight to the device and may prove to be possible failure points. This stove has inadequate openings for feeding the fuel. While functionality with canned heat may be good, it is clearly not designed for use with foraged fuels, and lacks the light weight desired for backpacking.

U.S. Pat. No. 4,140,099 Newport (1979) discloses a disposable trapezoidal-profiled stove basically rectangular in the top view. It collapses down to a profile approximately the size of the cooking surface which is a bit large for convenient stowage in the limited confines of a backpack. This stove has a fuel support surface adding to its overall weight. It is formed via a system of bends, and folded sleeves which could be easily bent and damages causing the device not to assemble. Depending on the gauge of sheet metal used, the stove may either prove too weak for heavy cooking loads, or excessively heavy for carrying. Air supply for combustion comes via two open ends, with no air vents on the sides. Having both ends open increases the danger of combusting materials escaping the burning chamber, especially when used in high wind conditions.

U.S. Pat. No. 4,794,906 Longley, Jr. (1989) discloses a rectangular box shaped stove that assembles with a system of hinged joints. The resulting cooking “surface” requires balancing a pan on the folded sides of the device limiting the sizes of pans that can be used in this configuration and creating challenges to the stability of the stove. The stove also has a fuel support surface on the bottom. The only way to feed the fuel during use is to remove the cooking pan and feed directly into the flames from above creating potentiality for burns and spills. If used in the inverted configuration, there is no way to feed the fuel without lifting the entire apparatus from the ground allowing the combusting fuels to potentially scatter.

U.S. Pat. No. 4,877,010 Hait (1989) discloses a rectangular stove with a combined trapezoidal side profile. The sides of this stove fold into place utilizing a system of hinges and notches. The stove has a base, a fuel support grid, and a cooking surface grid. The combustion area is insufficient for most foraged fuels, and the openings for supplying air to the combusting material are very limited. The only way to feed the fuel during use is to remove the cooking pan and feed directly into the flames from above creating potentiality for burns and spills. The slender profile and required stacking of the various parts detract from the unit's stability.

U.S. Pat. No. 4,971,045 Probst (1990) discloses a cube shaped stove fastened together with the use of opposing slots cut in the four sides of the stove. Additionally, this stove has a grate for holding fuel, and an ash tray. The fourth side of the device, along with the addition of the fuel grate and ash pan, increase the weight of the stove unnecessarily. There is no cooking grate or surface requiring the balancing of a pan or skewers on the edges of the sides, increasing instability. The only way to feed the fuel during use is to remove the cooking pan and feed directly into the flames from above creating potentiality for burns and spills.

U.S. Pat. No. 5,915,371 Herring (1999) discloses a cylindrical foraged fuel stove connected with folded seams on the edges of opposing semi-cylindrical pieces. A cooking platform is derived from a system of metal rods spanning the top. The higher-than-wide profile of this stove creates instability. The only way to feed the fuel during use is to remove the cooking pan and feed directly into the flames from above creating potentiality for burns and spills. When collapsed for stowage, the stove is still quite large and curved. It is to be carried by placing it around a rolled sleeping bag or pad. This exposes the soot-covered inside of the device to soil sleeping gear. Inner sleeves in the air intake area allow for variable airflow to the combusting material, but add weight to the device and potentiality for jamming on fuel or the device itself.

U.S. Pat. No. 6,520,173 Lautner (2003) discloses a tapered cylindrical stove that utilizes a tube for blowing air into the combustion chamber. The high, narrow profile of the device could make it unstable on uneven ground. There is no adequate opening to feed the fire during use, so one would likely need to remove the pan and feed the fire from above risking spills and burns. When stowed, the unit is nearly the full size as it is assembled, so it is not compact. Additionally, the fire grate, legs, tubing and high walls add unnecessary weight to the device further reducing its portability.

U.S. Pat. No. 7,107,983 West (2006) discloses a tapered cylindrical stove with a variety of permutations. This stove is designed such as to provide versatility in cooking methods including baking. However, all but one, are not designed to collapse into a compact unit conducive the requirements of backpacking. The one that does disassemble exposes the sooty inner cooking surface which allows soiling of other items co-packed. Additionally, while flat, it is still quite large. The device offers a variety of mechanisms to raise the combustion chamber from the soil, but they are subject to penetrating soft soils limiting air flow to the combustion chamber and creating instability. The variation of the device that allows for baking is neither light nor compact enough for practical backpacking applications. The high, narrow profile of the unit creates instability. In the “backpacking” version of the stove, the only way to feed the fuel during use is to remove the cooking pan and feed directly into the flames from above creating potentiality for burns and spills.

### BRIEF SUMMARY OF THE INVENTION

The portable, compact, light-weight, foraged-fuel stove described herein provides a sturdy, adequate cooking surface and while collapsed, forms a very compact case favorable in size and weight for easy storage in pocket, purse, or backpack. Two key components that distinguish this stove from other foraged fuel stoves, are the low-profile, square shape which enhances stability and safety while providing a multi-use cooking surface adequate for grilling as well as cooking with pans of most sizes, and how the pieces of the stove disassemble and reassemble into an unique, compact, self-contained carrying case containing any loose parts. The stove is designed to work with fuels foraged from one's surroundings, but is also suitable for use with charcoal, gelatinous fuels, alcohol burners, and more. By using foraged fuels, the backpacking weight of this stove is significantly minimized. The stove provides a large opening for adding fuel eliminating the need to move the cooking material to add fuel, and a system of smaller openings in the sides of the stove to allow for adequate airflow to sustain combustion of the fuel.

### BRIEF DESCRIPTION OF THE VIEWS OF THE DRAWING

FIG. 1 shows the exploded view of the components of the stove.

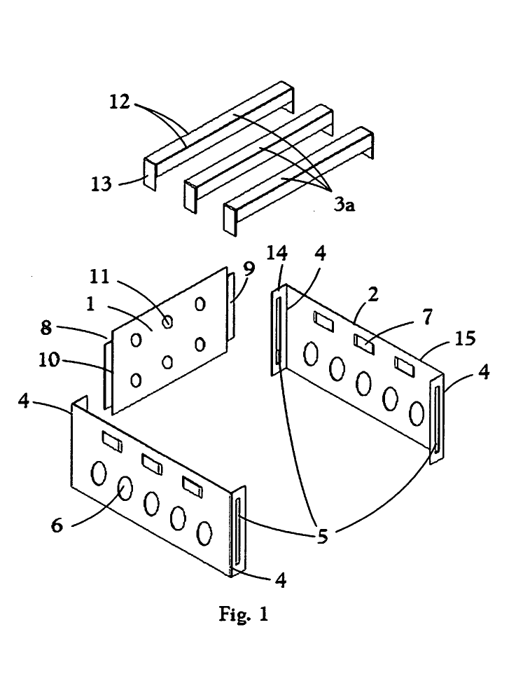

FIG. 2 shows the stove assembled for cooking use.

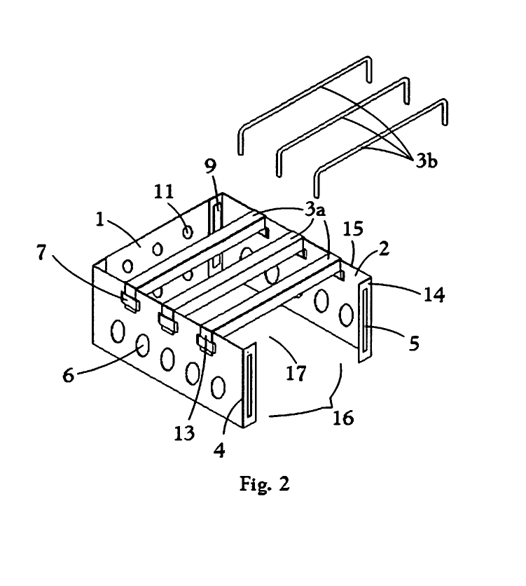

FIG. 3 shows the exploded view of the components of the stove aligned for assembling into its case form.

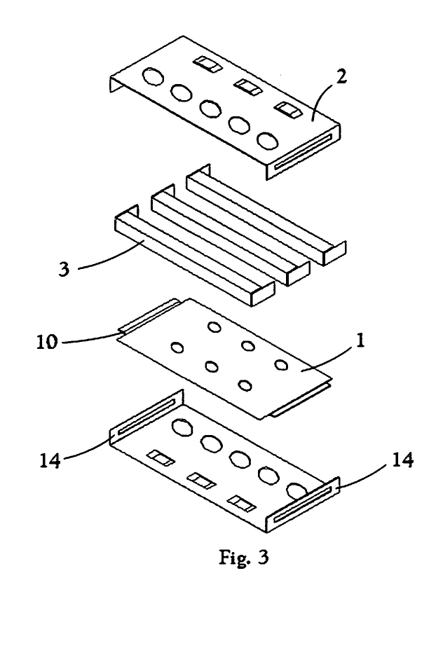

FIG. 4 shows the pieces assembled into its case form.

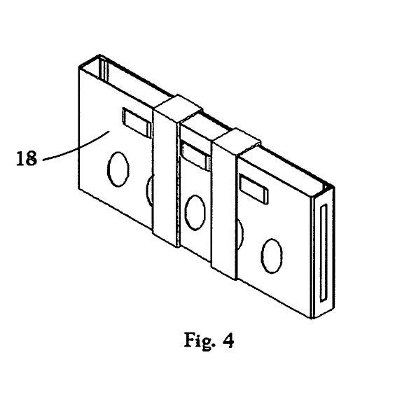

### DETAILED DESCRIPTION OF THE INVENTION

The components of the stove are two side walls(2), one back wall(1), and three cross members(3a/b) all comprised of sheet metal or other non-combustible material. The two side walls(2) are identical in form comprised of a rectangular sheet of metal or other non-combustible material with 90-degree bends(4) to the same direction on both ends and with open narrow slots(5) in the said bent portions(14) running parallel to the bends(4), and with a system of holes(6) on the lower main portion of the sidewalls(2) and three equally spaced bridge slots(7) cut and bended out opposing the direction of the end bends. The back wall(1) is rectangular, somewhat shorter than the side walls(2), with the corners of each end(8) notched out to form tabs(9) that are offset from the main plane of the material slightly; each with two opposing bends(10) such that the resulting tabs(9) run parallel to the main plane of the piece, and the main plane of the piece has a system of holes(11) along the lower and upper portion of the main plane and running parallel to the bottom or top edge of the same. The three cross members(3a) are identical in form with greater length than width, and 90-degree bends(12) in the same direction along each of the longer edges thus forming a “C” channel shaped cross member with the end portions(13) of the member bent 90-degrees in the same direction as the sides, but extending below the sides to form tabs(13), and the overall length of the cross members is marginally longer than the width of the assembled unit and yet somewhat shorter than the length of the side walls(2). Alternate cross members(3b) may be formed from non-flammable, rod material with ends bent to 90-degree angles in the same direction, similar to the end bends in the cross members(3a).

The stove is assembled by inserting the back wall offset tabs(9) into the slots(5) of the bent portion of the sidewalls(2) and then rotating the sidewalls(2) such that they are parallel and opposing each other with the end bends(14) of said side walls(2) pointing toward the opposing side wall(2) and such that both side walls(2) are running lengthwise 90 degrees to the back wall(1). Thus assembled, the offset tabs(9) of the back wall(1) lock in place via the offset of the back wall tabs(9) in the sidewall slots(5). Next, the three cross members(3a/b) are placed bridging the two side walls(2) with the cross member tabs(13) inserted into the outer bridge slots(7) locking the side walls(2) parallel to each other and with the side walls(2) perpendicular to the back wall(1) while the same cross pieces(3a/b) form a system of members spanning the width of the stove which along with the top edges(15) of the side walls(2) and back wall(1) form the generous cooking surface of the stove. The resulting unit is very stable and can support a surprising amount of weight without damage to the device enhancing safety for the user.

Foraged or other fuel such as gelatinous fuels, small sticks, twigs, grass, pine cones, charcoal, or other suitable, small, flammable material is then inserted through the large opening(16) opposing the back wall(1) of the device and combusted to provide heat for cooking or grilling. Additional fuel can be provided for combustion during the cooking process without disturbing the cooking pan or grilling material. Air for combustion of the fuel enters the combustion chamber(17) via the fuel feeding opening(16), and via the system of holes(11) in the back wall(1) and via the holes(6) in the side walls(2). Additionally, the holes(11,6) in the side walls(2) or back wall(1) can be shaped such as to present the name of the device or other symbolic graphics. The stove requires very little fuel and can bring large quantities of water to a boil expediently and safely.

To collapse the stove for storage, once cool, all the pieces of the stove above are disassembled. Then the cross members(3a/b) are nested together and placed, along with the back wall(1), in the space in a side wall(2) between the end bends(14) of the side wall(2). Then the other side wall(2) is placed opposing the direction of the first side wall with its end bends(14) flexed slightly and inserted between the end bends(14) of the first side wall(2) thus covering the cross members(3a/b) and back wall(1). Finally, the side walls(2) are held together using common strapping or cord thus locking the back wall(1) and cross members(3a/b) inside the opposing side walls(2). The resulting case(18) is very compact with the primary soot-collecting sides of each piece contained within the case(18) offering protection from soiling other items.

We claim:

1. A stove comprised of three flame-resistant side walls and cross members which fit together to form both a three-sided rectangular body for cooking and a compact, smaller rectangular case for storing the various parts whereas in cooking form, two of the sidewalls are identical in shape and size with 90-degree bent ends containing long vertical slots which receive offset tabs on the ends of the of the third sidewall, such that the two identical sidewalls can swing into an approximate right angle to the third side wall thus locking the sidewalls into the back wall when held at this angle by cross members placed over the top edge of the side walls, and inserted into bridged slots in the top outside of the sidewalls, and whereas in the storing-case form, the cross members and back wall nest inside of one sidewall's bent ends while the other side wall flexes its bent ends into the opposing bent ends forming a rectangular case that can be held together with common cords or straps.
